(19) United States
(12) Patent Application Publication
(10) Pub. No.: US 2025/0070585 A1
(43) Pub. Date: Feb. 27, 2025

(54) Control Strategy for Mixed Chemistry Battery Pack

(71) Applicant: GM GLOBAL TECHNOLOGY OPERATIONS LLC, Detroit, MI (US)

(72) Inventors: Jian Yao, Shanghai (CN); Shuonan Xu, Troy, MI (US); Yongjie Zhu, Troy, MI (US); Su-Yang Shieh, Clawson, MI (US); Chunhao J. Lee, Troy, MI (US); Chengwu Duan, Shanghai (CN)

(73) Assignee: GM GLOBAL TECHNOLOGY OPERATIONS LLC, Detroit, MI (US)

(21) Appl. No.: 18/602,319

(22) Filed: Mar. 12, 2024

(30) Foreign Application Priority Data
Aug. 21, 2023 (CN) 202311116902.7

(51) Int. Cl. H02J 7/00; B60L 50/60; B60L 53/62; H01M 10/0525; H01M 10/054; H01M 10/46; H01M 50/204; H01M 50/296; H01M 50/512

(52) U.S. Cl. CPC H02J 7/007194; B60L 50/60; B60L 53/62; H01M 10/0525; H01M 10/054; H01M 10/46; H01M 50/204; H01M 50/296; H01M 50/512; H02J 7/0013; B60L 2210/14; B60L 2240/547; H01M 2220/20

(57) ABSTRACT

An electrical system includes a high-voltage battery pack assembly having a first cell set with a first group of energy storage cells and a second cell set having a second group of energy storage cells connectable to the first cell set. The first cell set includes at least one first battery chemistry cell and the second cell set includes at least one second battery chemistry cell. At least one switch is in electrical communication with the first or second cell set. Battery connection terminals are in electrical communication with at least one of the first or second cell sets. A controller is configured to determine an operating strategy of the high-voltage battery pack assembly and place at least one of the first cell set or the second cell set in electrical communication with the battery connection terminals in response to the operating strategy of the high-voltage battery pack.

### CROSS-REFERENCE TO RELATED APPLICATIONS

This application claims priority to and the benefit of Chinese Patent Application No. 202311116902.7, which was filed on Aug. 21, 2023, and which is hereby incorporated by reference in its entirety.

### INTRODUCTION

Electrified powertrain systems of motor vehicles and other mobile electrical systems include an electrical system configured to energize one or more electric motors to generate motive torque. For example, an electric traction motor may be connected to the road wheels of an electric vehicle, with generated output torque being directed to the road wheels to propel the electric vehicle on a road surface. To this end, a high-voltage bus of the electric vehicle is connected to a rechargeable energy storage system (“RESS”), a principal component of which is a propulsion battery pack having an application-suitable number and configuration of electrochemical battery cells. The battery pack-to-motor connection is made through an intervening power inverter module when the electric traction motor is configured as a polyphase/alternating current (“AC”) machine.

### SUMMARY

Disclosed herein is an electrical system. The electrical system includes a high-voltage battery pack assembly having a first cell set with a first group of energy storage cells and a second cell set having a second group of energy storage cells connectable to the first cell set. The first cell set includes at least one first battery chemistry cell and the second cell set includes at least one second battery chemistry cell. At least one switch is in electrical communication with the first cell set or the second cell set. Battery connection terminals are in electrical communication with at least one of the first cell set or the second cell set. A controller is configured to determine an operating strategy of the high-voltage battery pack assembly and place at least one of the first cell set or the second cell set in electrical communication with the battery connection terminals in response to the operating strategy of the high-voltage battery pack.

Another aspect of the disclosure may be where the controller is configured to isolate the first cell set from the battery connection terminals when the operating strategy includes operating the electrical system at a temperature below a predetermined threshold.

Another aspect of the disclosure may be where the controller is configured to boost an output voltage of the second cell set with a DC-DC converter when the operating strategy includes operating the electrical system at a temperature below a predetermined threshold to heat the first cell set.

Another aspect of the disclosure may be where the controller is configured to match an output voltage of the second cell set to the first cell set with a DC-DC converter when the operating strategy includes operating the electrical system at a temperature below a predetermined threshold and the at least one switch places the first cell set in parallel with the second cell set.

Another aspect of the disclosure may be where the operating strategy includes operating the electrical system above a predetermined threshold temperature.

Another aspect of the disclosure may be where the controller is configured to position the at least one switch to place the first cell set in parallel with the second cell set.

Another aspect of the disclosure may be where the controller is configured to position the at least one switch to isolate the first cell set from the battery connection terminals until a second voltage across the second cell set is reduced to match a first voltage across the first cell set.

Another aspect of the disclosure may be where the controller is configured to utilize a DC-DC converter to boost an output voltage of the second cell set when the first cell set includes an output voltage greater than an output voltage of the second cell set.

Another aspect of the disclosure may be where the controller is configured to disconnect the second cell set from the battery connection terminals when an output voltage of the first cell set is greater than an output voltage of the second cell set.

Another aspect of the disclosure may be where the controller is configured to disconnect the first cell set from the battery connection terminals to charge the second cell set when the battery connection terminals are in electrical communication with a power charging source.

Another aspect of the disclosure may be where the controller is configured to bypass a DC-DC converter when charging the second cell set.

Another aspect of the disclosure may be where the controller is configured to isolate the second cell set when an output voltage of the second cell set reaches a predetermined charge threshold and the controller is configured to position the at least one switch to isolate the second cell set and charge the first cell set with the power charging source in electrical communication with the battery connection terminals.

Another aspect of the disclosure may be where the first cell set includes a group of lithium iron phosphate cells and at least one sodium-ion cell and the second cell set includes a group of sodium-ion cells.

Another aspect of the disclosure may be where the controller is configured to measure a state of charge of the first cell set by measuring a voltage across the at least one sodium-ion cell.

Another aspect of the disclosure may be where the controller is configured to position the at least one switch to place the second cell set in series with a DC-DC converter.

Another aspect of the disclosure may be where the first cell set includes a group of silicone anode cells, and the second cell set includes sodium-ion cells with the first cell set and the second cell set connected to a DC-DC converter.

Disclosed herein is a method of operating an electrical system. The method includes determining an operating strategy of a high-voltage battery pack assembly. The high-voltage battery pack assembly includes a first cell set and a second cell set connected to the first cell set. The first cell set includes at least one first battery chemistry and the second cell set includes at least one second battery chemistry cell. The method also includes placing the first cell set and the second cell set in electrical communication with battery connection terminals in response to the operating strategy of the high-voltage battery pack.

Disclosed herein is a vehicle system. The vehicle system includes a traction battery forming a high-voltage battery pack assembly having a first cell set and a second cell set connected to the first cell set. The first cell set includes at least one first battery chemistry cell and the second cell set includes a second battery chemistry cell. A traction motor is in communication with the traction battery. A controller is configured to determine an operating strategy of the high-voltage battery pack assembly. The controller is also configured to place at least one of the first cell set or the second cell set in electrical communication with battery connection terminals in response to the operating strategy of the high-voltage battery pack.

### BRIEF DESCRIPTION OF THE DRAWINGS

FIG. 1 illustrates an example electrical system configured to charge a high-voltage battery pack with the high-voltage battery pack configured to provide power to a low-voltage bus.

FIG. 2 is a schematic of an example battery pack assembly.

FIG. 3 illustrates an example method of operating the battery pack assembly of FIG. 2.

FIG. 4 illustrates another example battery pack assembly.

FIG. 5 illustrates a method of operating the battery pack assembly of FIG. 4.

FIG. 6 illustrates yet another example battery pack assembly.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

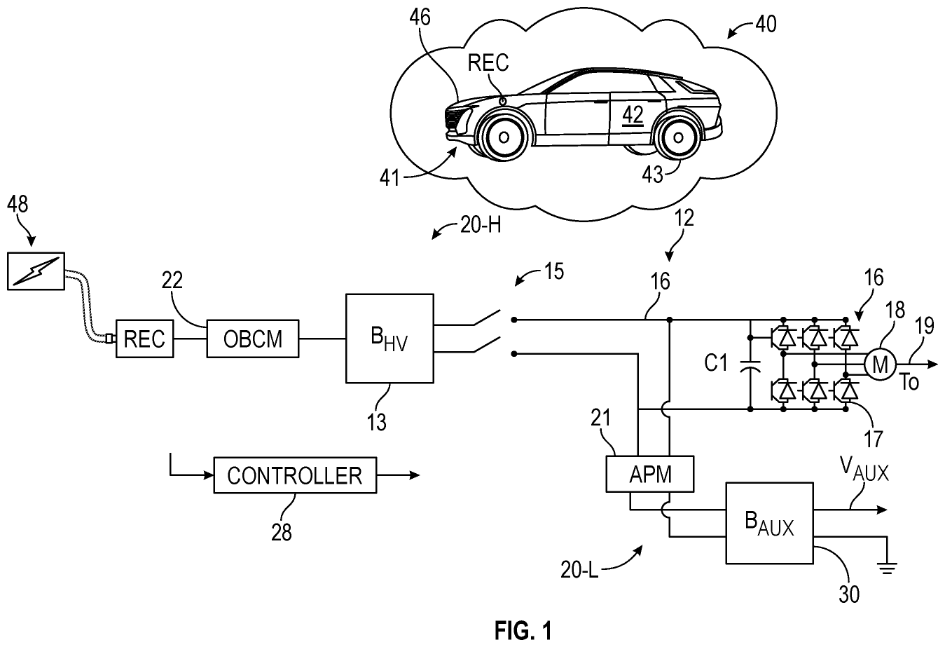

Referring to the drawings, like reference numerals correspond to like or similar components throughout the several Figures. FIG. 1 illustrates an electrical system 12, e.g., an electrified powertrain system of a motor vehicle 40 having a vehicle body 41 defining a vehicle interior 42. The motor vehicle 40 of FIG. 1 may also include a front trunk (“frunk”) 46 or another compartment providing user access to a charging receptacle REC. The motor vehicle 40 also includes road wheels 43 for traveling along roadways. The wheels 43 may be driven/powered through the electrical system 12 or undriven/freewheeling, as described in greater detail below.

The electrical system 12 includes separate high-voltage and low-voltage buses. The high-voltage bus 20-H is in electrical communication with a high-voltage battery pack assembly 13, such as a traction battery, and the low-voltage bus 20-L is in electrical communication with an auxiliary battery (“BAUX”) 30. At least on-board charging module (“OBCM”) 22-include inputs in communication with the charging receptacle REC as power converters to convert an AC power source from a charge station 48 to DC power at an outlet to charge the battery pack assembly 13. At least one auxiliary power module (“APM”) 21 isolate the high-voltage bus 20-H from the low-voltage bus 20-L with input in communication with the high-voltage bus 20-H and outputs in communication with the low-voltage bus 20-L to charge the auxiliary battery 30 and power vehicle accessories, such as heated seats, power windows, or navigation systems. The OBCM 22 and APM 21 are both in communication with an electronic controller 28 in the electrical system 12.

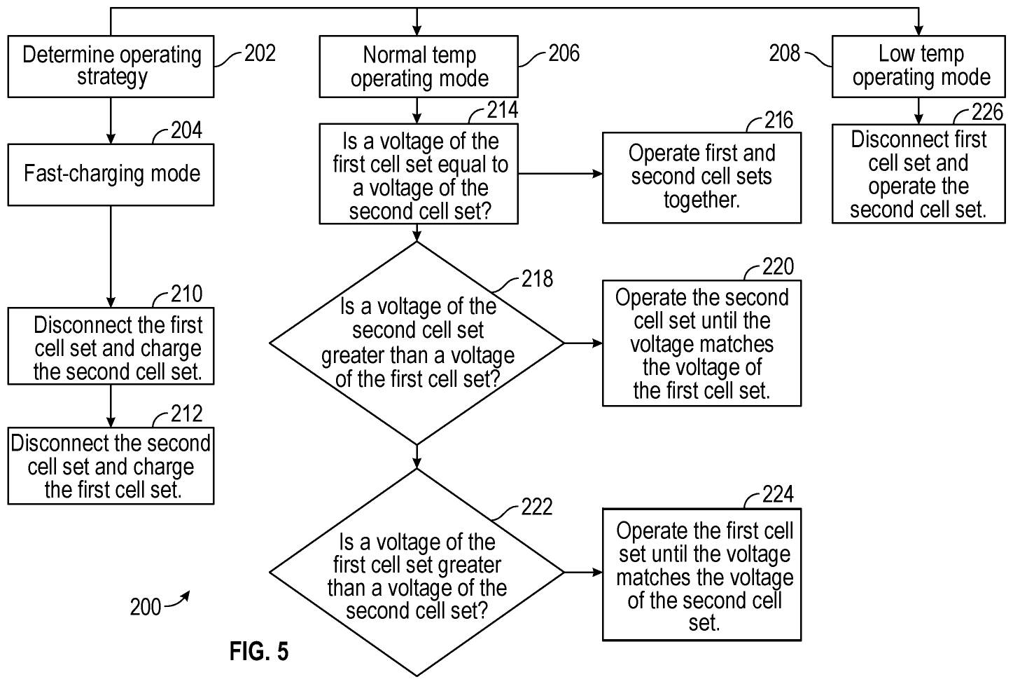

The electronic controller 28 may include a computer and/or processor, and include software, hardware, memory, algorithms, connections, etc., for managing and controlling the operation of the motor vehicle 40. As such, a method, described below and generally represented in FIG. 5, may be embodied as a program or algorithm partially operable on the controller 28. It should be appreciated that the controller 28 may include a device capable of analyzing data from the sensors, comparing data, making the decisions required to control the operation of the motor vehicle 40, and executing the required tasks to control the operation of the motor vehicle 40.

The controller 28 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The controller 28 includes a tangible, non-transitory memory on which computer-executable instructions, including one or more algorithms, are recorded for regulating operation of the motor vehicle 40. The subject algorithm(s) may specifically include an algorithm configured to optimize energy usage of the motor vehicle 40.

In the illustrated example, features and functions of the power converters, such as the auxiliary power module 21 or the on-board charge modules 22 of FIG. 1, may be partially or fully integrated into the structure of the electrical system 12. Moreover, the present teachings apply to a wide range of mobile and stationary variations of the electrical system 12, including but not limited to electrified powertrain systems of aircraft, marine vessels, railed vehicles, farm equipment, transport equipment, and other land, sea, or airborne mobile platforms, as well as powerplants, hoists, conveyor systems, and the like. The descriptions herein of the particular vehicular use scenario shown in FIG. 1 are, therefore, non-limiting and illustrative of just one possible implementation.

Further, concerning the representative electrical system 12 of FIG. 1, the electrical system 12 is characterized by its separate high-voltage and low-voltage buses which are respectively labeled “20-H” and “20-L”. For embodiments in which the electrical system 12 is part of the motor vehicle 40, e.g., an electric vehicle constructed as a battery electric vehicle, a hybrid electric vehicle, or an extended-range electric vehicle, the term “high-voltage” may encompass battery voltage capabilities of about 300 volts (V) or more. Such voltage levels are suitable for generating motive torque for vehicular propulsion functions and for powering various high-voltage accessories aboard the motor vehicle 40. The term “low-voltage” for its part refers to auxiliary voltage levels, typically 12-50V. Low-voltage conductors (not shown) thus connect the low-voltage bus 20-L to one or more low-voltage accessories located aboard the motor vehicle 40, including but not limited to lights, radios, infotainment screens, sensors, etc.

In the exemplary embodiment of FIG. 1, the battery pack assembly 13 is selectively connected to and disconnected from a load by a set of high-voltage contactors 15. The applied load in the illustrated configuration includes a direct current (“DC”) link capacitor (C1), a power inverter module (“inverter”) 16 having a plurality of semiconductor switches 17 connected to an electric traction motor (“M”) 18. As appreciated in the art, inverters such as the inverter 16 shown in FIG. 1 utilize multiple dies of the semiconductor switches 17 as fast-responding ON/OFF switching devices, e.g., insulated gate bipolar transistors (“IGBTs”), metal oxide semiconductor field-effect transistors (“MOSFETs”), thyristors, etc. In a typical three-phase configuration of the electric traction motor 18, the semiconductor switches 17 are turned ON or OFF at predetermined switching intervals to output an alternating current (“AC”) waveform to the electric traction motor 18.

The electric traction motor 18 shown in FIG. 1 is connected to a rotatable output member 19, such as a motor shaft and connected gears (not shown). During drive modes, the inverter 16 is controlled with pulse width modulation (“PWM”) or another application-suitable switching control technique to energize phase windings of the electric traction motor 18. As depicted, the electric traction motor 18 is a polyphase AC motor, in this instance exemplified as a three-phase machine. Rotation of the output member 19 ultimately transfers torque (To) to a coupled load, including one or more road wheels 43 of the motor vehicle 40. During discharge/propulsion modes, electrical energy stored in constituent electrochemical battery cells (not shown) of the high-voltage battery pack assembly 13 is used to power rotation of one or more of the road wheels 43. Other embodiments of the motor vehicle 40 may use more or fewer road wheels 43. Additionally, some of the road wheels 43 could be undriven/freewheeling, e.g., in rear-wheel drive or front-wheel drive configurations, or the road wheels 43 may be driven/powered, e.g., in an all-wheel drive or four-wheel drive configuration, without limitation.

The electrical system 12 of FIG. 1 may also include additional components for powering various systems or functions aboard the motor vehicle 40. For example, the high-voltage battery pack assembly 13 as depicted is connected to the APM 21. As such, the APM 21 is operable to reduce a level of a DC voltage of the high-voltage bus 20-H, e.g., 300V or more as noted above, to a typical 12-50V auxiliary voltage level for the low-voltage bus 20-L. The auxiliary battery 30, such as a 12V/48V lead-acid or lithium auxiliary battery, may be electrically connected to the APM 21 with internal switching operation of the APM ensuring that the auxiliary battery 30 remains charged, i.e., that the auxiliary battery voltage (V_{Aux}) equals about 12-50V.

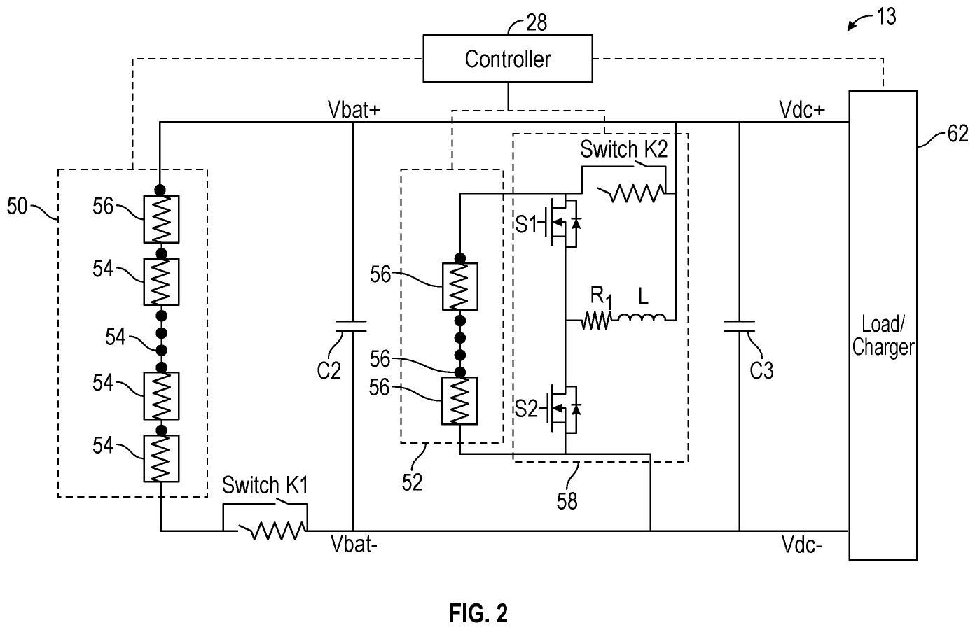

FIG. 2 illustrates an example high-voltage battery pack assembly 13. In the illustrated example, the high-voltage battery pack assembly 13 includes a first plurality of energy storage cells, such as a first cell set 50, and a second plurality of energy storage cells, such as the second cell set 52. The first cell set 50 is connected to the second cell set 52 in a parallel electrical configuration. The first cell set 50 includes at least one first battery chemistry cell 54 connected in series with at least one second battery chemistry cell 56. The second cell set 52 includes a plurality of second battery chemistry cells 56 connected in series without having the first battery chemistry cells 54.

In the illustrated example, the first battery chemistry cells 54 include lithium iron phosphate (LFP) cells and the second battery chemistry cells 56 include sodium-ion cells and are arranged in parallel with a capacitor C2 spanning between V_{bat+} and V_{bat-}. One feature of utilizing the second battery chemistry cells 56 with the first battery chemistry cells 54 in the first cell set 50 is an improved ability to estimate state of charge/health (SOC/SOH) across the first cell set 50. In particular, the first battery chemistry cells 54 dissipate voltage in a non-linear manner, while the second chemistry cells 56 dissipate energy in a more linear manner with a more linear relationship curve between SOC/SOH and voltage. Therefore, a voltage can be measured across the at least one second battery chemistry cell 56 in the first cell set 50 to provide an estimated SOC/SOH of the first cell set 50. In the illustrated example, the first cell set 50 includes an amp hour (Ah) rating of greater than two times an Ah rating of the second cell set 52. For example, the first cell set 50 could include a 150 Ah storage capacity and the second cell set 52 include a 50 Ah storage capacity.

The second cell set 52 is configured in a series with a DC-DC converter 58. The DC-DC converter 58 includes semiconductor switches S1 and S2 in series with resistor R_{L}. and inductor L. The DC-DC converter 58 is utilized when a switch K2 is open and the DC-DC converter 58 is bypassed when the switch K2 is closed. One feature of the DC-DC converter 58 is varying an output voltage of the second cell set 52 to match a voltage of the first cell set 50. Alternatively, the DC-DC converter 58 can increase the voltage of the second cell set 52 to be greater than the voltage of the first cell set 50 as will be discussed in greater detail below. A capacitor C3 is in parallel with the second cell set 52 and the DC-DC converter 58 spans between voltage V_{dc+} and V_{dc-}.

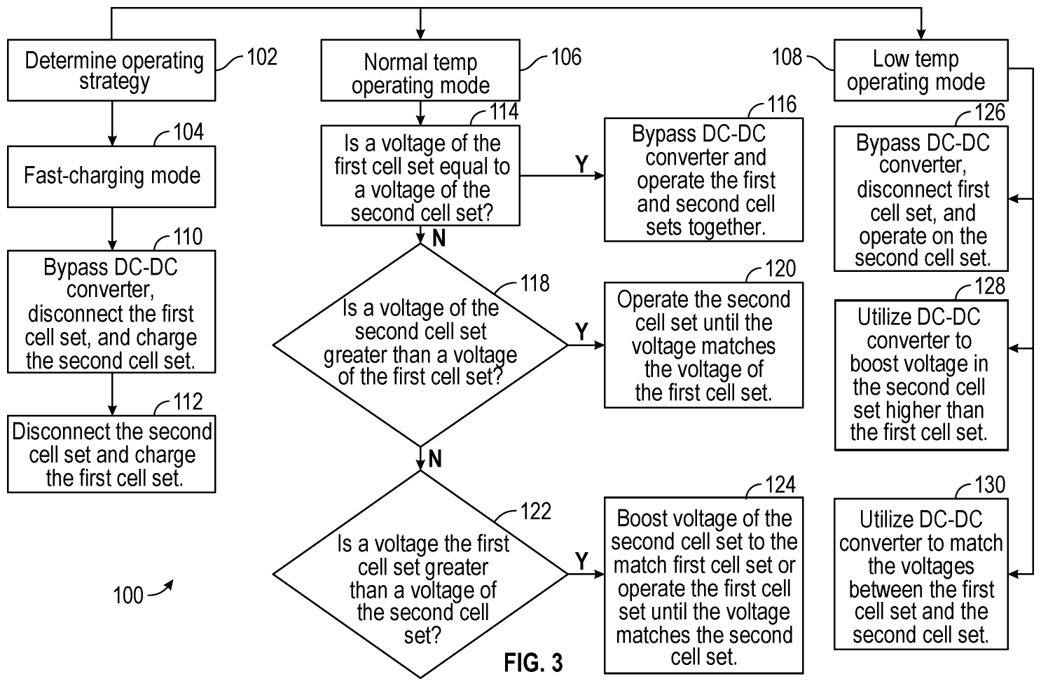

FIG. 3 illustrates an example method 100 of operating the battery pack assembly 13. The method 100 begins with determining an operating strategy for the battery pack assembly 13 (Block 102). In the illustrated example, the operating strategies include a fast-charging mode (Block 104), a normal temp operating mode (Block 106), and a low temp operating mode (Block 108). The first and second cell sets 50, 52 are positioned in parallel or in series with battery connection terminals at a load/charger 62 depending on the operating strategy of the battery pack assembly 13.

When the selected operating strategy includes the fast-charging mode from Block 104, the method 100 begins with charging the second cell set 52 with a power charging source, such as the load/charger 62 (Block 110). To charge the second cell set 52, the method 100 bypasses the DC-DC converter 58 by closing switch K2 and disconnects the first cell set 50 by opening the switch K1. One feature of charging the second cell set 52 separately from the first cell set 50 is that the second cell set 52 charges more quickly than the first cell set 50 due to the difference in battery chemistries between the two cell sets. This allows the battery pack assembly 13 to initially gain a greater charge percentage more quickly because the second cell set 52, which are sodium-ion cells, charge at a faster rate than the first cell set 50, which are mostly LFP cells. Once the second cell set 52 has been charged to a desired level, the second cell set 52 is disconnected by opening the switch K2 and closing the switch K1. The first cell set 50 can then be charged to a desired predetermined charge level (Block 112).

When the selected operation strategy includes the normal temperature operating mode from Block 106, the method 100 compares the voltages of the first cell set 50 to the second cell set 52. If the voltage of the first cell set 50 is equal to the second cell set 52 (Block 114), the DC-DC converter 58 is bypassed by closing the switch K2, and the first cell set 50 and the second cell set 52 are operated together in parallel (Block 116) to provide power to the load 62.

If the voltages of the first cell set 50 and the second cell set 52 are not equal, then the method 100 will proceed to Block 118. At Block 118, the method 100 will determine if the voltage of the second cell set 52 is greater than the voltage of the first cell set 50. If the voltage of the second cell set 52 is greater than the voltage of the first cell set 50, the method 100 will proceed to Block 120. At Block 120, the method will disconnect the first cell set 50 by opening the switch Kl and closing the switch K2 to use the second cell set 52 to power the load 62. The method 100 will use the second cell set 52 to power the load 62 until the voltage of the second cell set 52 matches the voltage of the first cell set 50. When the voltage of the first cell set 50 matches the voltage of the second cell set 52, both the first and second cell sets 50, 52 can be operated together in parallel to provide power to the load 62. If the method determines that the voltage of the second cell set 52 is not greater than the voltage of the first cell set 50, the method 100 will proceed to Block 122.

At Block 122, the method 100 will determine if the voltage of the first cell set 50 is greater than the voltage of the second cell set 52. If the voltage of the first cell set 50 is greater than the voltage of the second cell set 52, the method 100 will proceed to Block 124. At Block 124, the method 100 can direct the DC-DC converter 58 to boost the voltage of the second cell set 52 to match the voltage of the first cell set 50 to provide power to the load 62 with the first and second cell sets 50, 52 in parallel.

Alternatively, the method 100 can disconnect the second cell set 52 from the load 62 by opening the switch K2 and providing power to the load 62 with the first cell set 50 until the voltage of the first cell set 50 matches the voltage of the second cell set 52. When the voltages of the first and second cell sets 50, 52 match, both the first and second cell sets 50, 52 can be used in parallel to provide power to the load 62.

When the operating strategy includes the low temperature operating mode (Block 108), the method 100 can select one of the operations from Blocks 126, 128, or 130. In one example, low temperatures are below negative 10 degrees Celsius (14 degrees Fahrenheit). At Block 126, the method 100 will bypass the DC-DC converter 58 by closing the switch K2 and disconnecting the first cell set 50 by opening the switch K1. This configuration will provide power to the load 62 with only the second cell set 52. One feature of this configuration is that the second cell set 52 operates with improved performance at low temperatures when compared to the first cell set 50.

Alternatively, the method 100 can proceed to Block 128. At Block 128, the method 100 utilizes the DC-DC converter 58 to boost the voltage of the second cell set 52 to be greater than the voltage of the first cell set 50. The boost in voltage of the second cell set 52 relative to the first cell set 50 heats the cells in the first cell set 50 to improve operating performance of the first cell set 50 at the lower temperature.

Furthermore, the method 100 can proceed to Block 130. At Block 130, the method 100 can utilize the DC-DC converter 58 to match the voltage of the second cell set 52 with the voltage of the first cell set 50. This configuration allows the second cell set 52 with improved low temperature operation to share providing power to the load 62.

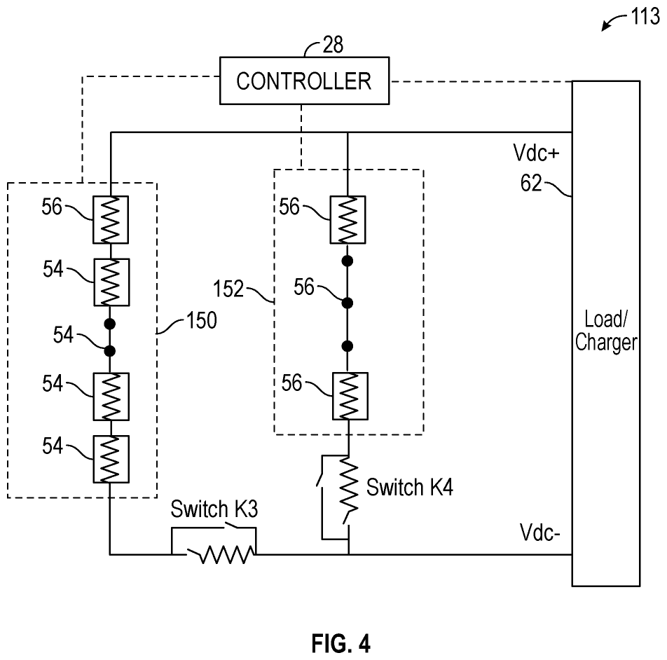

FIG. 4 illustrates another example battery pack assembly 113. The battery pack assembly 113 is similar to the battery pack assembly 13 except where described below or shown in the drawings. Like numbers will be used between similar components between the battery pack assembly 13 and the battery pack assembly 113 with the addition of a leading “1”.

In the illustrated example, the high-voltage battery pack assembly 113 includes a first plurality of energy storage cells, such as a first cell set 150, and a second plurality of energy storage cells, such as a second cell set 152. The first cell set 150 is connected to the second cell set 152 in a parallel electrical configuration. The first cell set 150 includes at least one first battery chemistry cell 54 connected in series with at least one second battery chemistry cell 56.

The second cell set 52 includes a plurality of second battery chemistry cells 56 connected in series without having the first battery chemistry cells 54. In the illustrated example, the first cell set 50 includes an amp hour (Ah) rating of greater than two times an Ah rating of the second cell set 52. The switches K3 and K4 are used to connect the first and second cell sets 150, 152 in series or parallel with the load/charger 62 depending on the operating strategy selected.

FIG. 5 illustrates an example method 200 of operating the battery pack assembly 113. The method 200 begins with determining an operating strategy for the battery pack assembly 113 (Block 202). In the illustrated example, the operating strategies include a fast-charging mode (Block 204), a normal temp operating mode (Block 206), and a low temp operating mode (Block 208). The first and second set of cells 150, 152 are positioned in parallel or series with battery connection terminals at the load/charger 62 depending on the operating strategy of the battery pack assembly 113 selected.

When the selected operating strategy includes the fast-charging mode from Block 204, the method 200 begins with charging the second cell set 152. To charge the second cell set 152, the method 200 bypasses the first cell set 150 by opening switch K3 and closing the switch K4 (Block 210). This allows the battery pack assembly 113 to gain a greater initial charge percentage as discussed above with respect to the battery pack assembly 13. Once the second cell set 152 has been charged to a desired level, the second cell set 152 is disconnected by opening the switch K4 and closing the switch K3. The first cell set 150 can then be charged to a desired charge level (Block 212).

When the selected operating strategy includes normal temperature operating mode from Block 206, the method 200 compares the voltages of the first cell set 150 to the second cell set 152 (Block 214). If the voltage of the first cell set 150 is equal to the second cell set 52, the first cell set 150 and the second cell set 152 are operated together in parallel (Block 216) to provide power to the load 62.

If the voltages of the first cell set 150 and the second cell set 152 are not equal, then the method 200 will proceed to Block 218. At Block 218, the method 200 will determine if the voltage of the second cell set 152 is greater than the voltage of the first cell set 150. If the voltage of the second cell set 152 is greater than the voltage of the first cell set 150, the method 200 will proceed to Block 220. At Block 220, the method 200 will disconnect the first cell set 150 by opening the switch K3 and closing the switch K4 to utilize the second cell set 152 to provide power to the load 62. The method 200 will continue to utilize the second cell set 152 to provide power to the load 62 until the voltage of the second cell set 152 matches the voltage of the first cell set 150. When the voltage of the first cell set 150 matches the voltage of the second cell set 152, both the first and second cell sets 150, 152 can be operated together in parallel to provide power to the load 62. If the method 200 determines that the voltage of the second cell set 152 is not greater than the voltage of the first cell set 150, the method 200 will proceed to Block 222.

At Block 222, the method 200 will determine if the voltage of the first cell set 150 is greater than the voltage of the second cell set 152. If the voltage of the first cell set 150 is greater than the voltage of the second cell set 152, the method 200 will proceed to Block 224. At Block 224, the method 200 can disconnect the second cell set 152 from the load 62 by opening the switch K4 and closing the switch K3 to provide power the load 62 with the first cell set 150 until the voltage of the first cell set 150 matches the voltage of the second cell set 152. When the voltages of the first and second cell sets 150, 152 match, both the first and second cell sets 150, 152 can be used in parallel to provide power to the load 62.

When the operating strategy includes the low temperature operating mode (Block 208), the method 200 proceeds to Block 226. At Block 226, the method 200 opens the switch K3 to disconnect the first cell set 150 from the load 62 and closes the switch K4 to connect the second cell set 152 with the load 62. One feature of this configuration is that the second cell set 152 operates with improved performance at low temperatures when compared to the first cell set 150 due to the variations in battery chemistry.

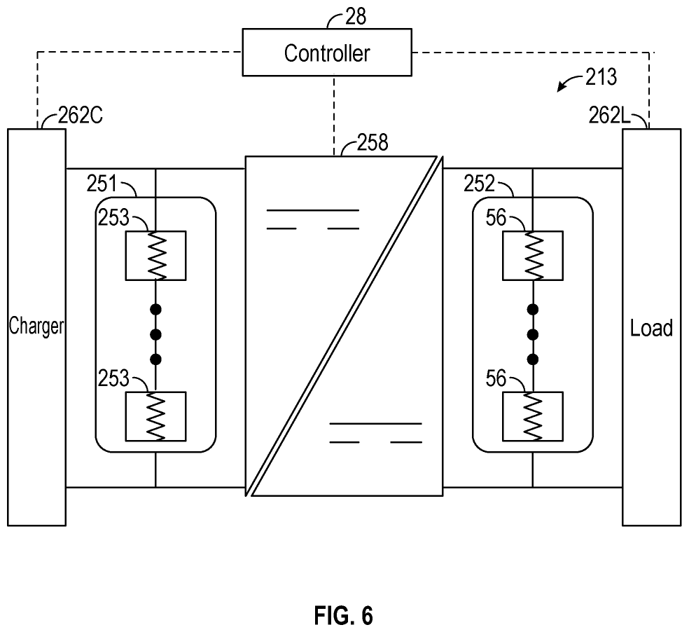

FIG. 6 illustrates yet another example battery pack assembly 213. The battery pack assembly 213 is similar to the battery pack assembly 13 except where described above or shown in the drawings. Like numbers will be used between similar components between the battery pack assembly 13 and the battery pack assembly 213 with the addition of a leading “2”.

In the illustrated example, the high-voltage battery pack assembly 213 includes a first plurality of energy storage cells, such as a first cell set 251, and a second plurality of energy storage cells, such as the second cell set 252. The first cell set 251 is connected in parallel with a charger 262C and a DC-DC converter 258, such as a bi-directional buck and booster DC-DC converter. The first cell set 251 includes at least one additional battery chemistry cell 253, such as silicone anode cells, connected in series to each other.

The second cell set 252 is connected in parallel with a load 262L and the DC-DC converter 258. The second cell set 252 includes a plurality of second battery chemistry cells 56 connected in series without having other chemistry cells in the second cell set 252.

When charging the first and second cell sets 251, 252, the first cell set 251 is connected directly to the charger 262C such that the cells 253 are not limited by an output of the DC-DC converter 258. The second cell set 252 charges at a rate limited by an output of the DC-DC converter 258. The DC-DC converter 258 can be sized based on continuous discharge requirements and direct current fast charge (DCFC) requirements. In particular, the DC-DC converter 258 is sized such that its output is greater than a maximum DCFC current rate of the cells 56 in the second cell set 252. Also, the DC-DC converter 258 can be sized such that its maximum output is greater than a maximum continuous discharge portion of the motor vehicle 40. One feature of the batter pack assembly 213 is the long cycle life of the cells 252 with Si-anode cells and the cost reduction of using the sodium-ion cells 56 as compared to using all Si-anode cells.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An electrical system comprising:
a high-voltage battery pack assembly including:
a first cell set having a first plurality of energy storage cells; and
a second cell set having a second plurality of energy storage cells connectable to the first cell set, wherein the first cell set includes at least one first battery chemistry cell and the second cell set includes at least one second battery chemistry cell;
at least one switch in electrical communication with the first cell set or the second cell set;
battery connection terminals in electrical communication with at least one of the first cell set or the second cell set; and
a controller configured to:
determine an operating strategy of the high-voltage battery pack assembly; and
place at least one of the first cell set or the second cell set in electrical communication with the battery connection terminals in response to the operating strategy of the high-voltage battery pack.

2. The electrical system of claim 1, wherein the controller is configured to isolate the first cell set from the battery connection terminals when the operating strategy includes operating the electrical system at a temperature below a predetermined threshold. 3 The electrical system of claim 1, wherein the controller is configured to boost an output voltage of the second cell set with a DC-DC converter when the operating strategy includes operating the electrical system at a temperature below a predetermined threshold to heat the first cell set.

4. The electrical system of claim 1, wherein the controller is configured to match an output voltage of the second cell set to the first cell set with a DC-DC converter when the operating strategy includes operating the electrical system at a temperature below a predetermined threshold and the at least one switch places the first cell set in parallel with the second cell set.

5. The electrical system of claim 1, wherein the operating strategy includes operating the electrical system above a predetermined threshold temperature.

6. The electrical system of claim 5, wherein the controller is configured to position the at least one switch to place the first cell set in parallel with the second cell set.

7. The electrical system of claim 5, wherein the controller is configured to position the at least one switch to isolate the first cell set from the battery connection terminals until a second voltage across the second cell set is reduced to match a first voltage across the first cell set.

8. The electrical system of claim 5, wherein the controller is configured to utilize a DC-DC converter to boost an output voltage of the second cell set when the first cell set includes an output voltage greater than an output voltage of the second cell set.

9. The electrical system of claim 5, wherein the controller is configured to disconnect the second cell set from the battery connection terminals when an output voltage of the first cell set is greater than an output voltage of the second cell set.

10. The electrical system of claim 1, wherein the controller is configured to disconnect the first cell set from the battery connection terminals to charge the second cell set when the battery connection terminals are in electrical communication with a power charging source.

11. The electrical system of claim 10, wherein the controller is configured to bypass a DC-DC converter when charging the second cell set.

12. The electrical system of claim 10, wherein the controller is configured to isolate the second cell set when an output voltage across of the second cell set reaches a predetermined charge threshold and the controller is configured to position the at least one switch to isolate the second cell set and charge the first cell set with the power charging source in electrical communication with the battery connection terminals.

13. The electrical system of claim 1, wherein the first cell set includes a plurality of lithium iron phosphate cells and at least one sodium-ion cell and the second cell set includes a plurality of sodium-ion cells.

14. The electrical system of claim 13, wherein the controller is configured to measure a state of charge of the first cell set by measuring a voltage across the at least one sodium-ion cell.

15. The electrical system of claim 13, wherein the controller is configured to position the at least one switch to place the second cell set in series with a DC-DC converter.

16. The electrical system of claim 1, wherein the first cell set includes a plurality of silicone anode cells and the second cell set include sodium-ion cells with the first cell set and the second cell set connected to a DC-DC converter.

17. A method of operating an electrical system, the method comprising:
determining an operating strategy of a high-voltage battery pack assembly, wherein the high-voltage battery pack assembly includes a first cell set and a second cell set connected to the first cell set, wherein the first cell set includes at least one first battery chemistry cell and the second cell set includes at least one second battery chemistry cell; and
placing the first cell set and the second cell set in electrical communication with battery connection terminals in response to the operating strategy of the high-voltage battery pack.

18. The method of claim 17, including isolating the first cell set from the battery connection terminals when the operating strategy includes operating the electrical system at a temperature below a predetermined threshold.

19. The method of claim 17, including positioning at least one switch to place the first cell set in parallel with the second cell set when the operating strategy includes operating the electrical system above a predetermined threshold temperature.

20. A vehicle system comprising:
a traction battery forming a high-voltage battery pack assembly having a first cell set and a second cell set connected to the first cell set, wherein the first cell set includes at least one first battery chemistry cell and the second cell set includes a second battery chemistry cell;
a traction motor in communication with the traction battery; and
a controller configured to:
determine an operating strategy of the high-voltage battery pack assembly; and
place at least one of the first cell set or the second cell set in electrical communication with battery connection terminals in response to the operating strategy of the high-voltage battery pack.
